(19) United States
(12) Patent Application Publication
(10) Pub. No.: US 2008/0137230 A1
(43) Pub. Date: Jun. 12, 2008

(54) EMI protective magnetic read head

(75) Inventor: Chia-Mao Shiao, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/637,464

(22) Filed: Dec. 11, 2006

(51) Int. Cl. G11B 5/187

(52) U.S. Cl. 360/122

(57) ABSTRACT

An EMI protective magnetic read head for use in a magnetic rule position feedback system to read signal from a magnetic rule is disclosed to include a sensor for reading signal from a magnetic rule, and an outer shell that houses the sensor and is made out of a magnetic conductive material, for example, pure ferrite or silicon steel that guides surrounding electromagnetic noises away from the sensor when the sensor is reading a magnetic rule.

### BACKGROUND OF THE INVENTION

1. Field of the Invention

The present invention relates linear encoders and more particularly, to an EMI protective magnetic read head for linear encoder that has its outer shell made out of a magnetic conductive material for EMI (Electromagnetic Interference) protection.

2. Description of the Related Art

A linear encoder or the so-called magnetic rule position feedback system is a position feedback control system that is intensively used in linear motion devices. It is essentially comprised of a magnetic gauge rule (the so-called magnetic rule), a magnetic read head, and a detection circuit.

The so-called magnetic rule contains equal pitch magnetized information that constitutes a magnetic grid. The strength of the magnetic field of the magnetic rule shows a periodic variation. When the magnetic read head reads (induces) displacement of the magnetic grid signal, the sensor of the magnetic read head induces a sine signal via the magnetic rule. The induced sine signal is then sent to a display counter or position detection control loop, thereby achieving a displacement measurement for server control.

According to the aforesaid principle, accurate receiving of intensity of magnetic field from the magnetic rule by the sensor in the linear encoder directly affects reliability of position feedback signal. In case the linear encoder is operating under an EMI (Electromagnetic Interference) environment, environmental noises will affect the accuracy of the magnetic read head in detecting the magnetic field of the magnetic rule, causing the magnetic read head to obtain an abnormal detection signal value or distortion and resulting in an error measuring result.

A regular magnetic read head for linear encoder generally has an outer shell made out of aluminum or zinc alloy that contains only a small amount of ferrite. This structure of outer shell cannot effectively eliminate electromagnetic interference, and therefore the regular magnetic read head cannot eliminate the reading error.

FIG. 5 is a schematic drawing showing the signal reading operation of the magnetic read head relative to a magnetic rule under external magnetic noises according to the prior art. As illustrated, the magnetic read head 802 comprises a sensor 80, and an outer shell 801, which houses the sensor 80. The outer shell 801 may be made out of zinc alloy, which contains ferrite as low as 0.3%-0.4%, or zinc alloy, which contains ferrite about 0.075%. When the sensor 80 of the magnetic read head 802 is reading a magnetic rule 90 under an environment having electromagnetic noises 60, the sensor 80 simultaneously reads in electromagnetic noises 60, thereby resulting in a detection error.

### SUMMARY OF THE INVENTION

The present invention has been accomplished under the circumstances in view. It is therefore the main object of the present invention to provide a magnetic read head for linear encoder, which effectively eliminates electromagnetic interference. To achieve this and other objects of the present invention, the EMI protective magnetic read head comprises a sensor, and an outer shell that houses the sensor. The outer shell is made out of a magnetic conductive material, for example, pure ferrite or silicon steel that guides surrounding electromagnetic noises away from the sensor when the sensor is reading a magnetic rule.

### BRIEF DESCRIPTION OF THE DRAWINGS

FIG. 1 is a schematic drawing showing the principle of the operation of a regular linear encoder.

FIG. 2 is a schematic top view of a magnetic read head and an EMI protective magnetic rule according to the present invention.

FIG. 3 is a schematic drawing showing the variation of the magnetic field of the magnetic rule induced by the EMI protective magnetic read head according to the present invention.

FIG. 4 is a schematic drawing showing the signal reading operation of the magnetic read head relative to a magnetic rule under external magnetic noises according to the present invention.

FIG. 5 is a schematic drawing showing the signal reading operation of a magnetic read head relative to a magnetic rule under external magnetic noises according to the prior art.

### DETAILED DESCRIPTION OF THE PREFERRED EMBODIMENT

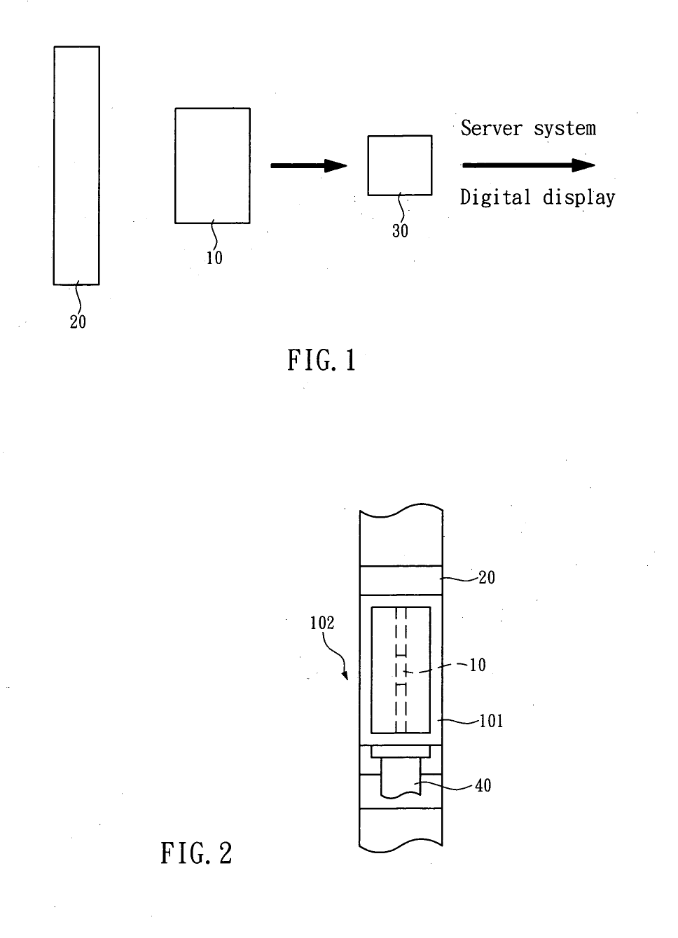

FIG. 1 is a schematic drawing showing the principle of the operation of a regular linear encoder. As illustrated, the magnetic sensor 10 of the magnetic read head reads the variation of the magnetic field of a magnetic rule 20 and then sends the detected signal to a detection circuit 30 for processing, for enabling the processed signal to be further sent by the detection circuit 30 to the linear motion device in which the linear encoder is installed for server control.

FIG. 2 shows the relationship between the magnetic sensor 10 of the magnetic read head 102 and the magnetic rule 20. As illustrated, a signal line 40 extends out of the magnetic read head 102 for transmitting the signal detected by the magnetic read head 102 to the aforesaid detection circuit 30.

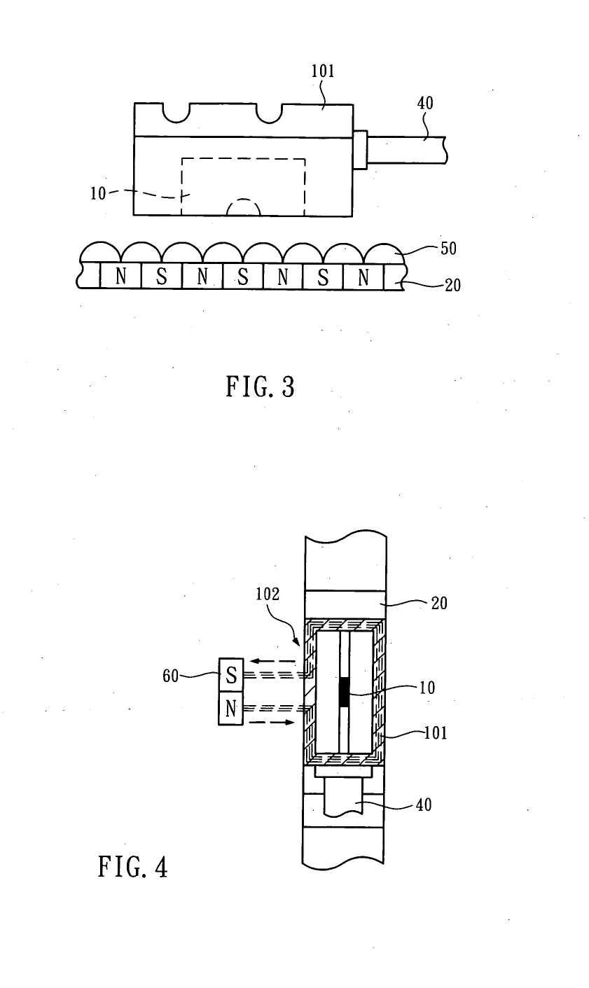

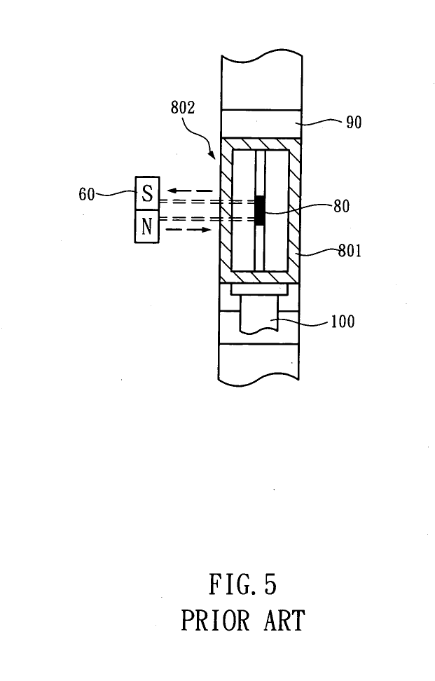

Referring to FIG. 3, the magnetic read head 102 comprises an outer shell 101 made out of a magnetic conductive material containing ferrite at least 50%, and the aforesaid magnetic sensor 10 mounted inside the outer shell 101. The magnetic conductive material can be pure iron or silicon steel.

Referring to FIG. 4, when the magnetic sensor 10 of the magnetic read head 102 is reading signal from the magnetic rule 20 under an environment having electromagnetic noises 60, the magnetic conductive material of the outer shell 101 guides electromagnetic noises 60 away from the magnetic read head 102, preventing electromagnetic interference. Therefore, the magnetic read head 102 can read the variation of the magnetic field of the magnetic rule 20 accurately, enabling the linear encoder to obtain the accurate position feedback signal for accurate control.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An EMI protective magnetic read head for use in a magnetic rule position feedback system to read signal from a magnetic rule, comprising an outer shell and a sensor housed inside said outer shell, wherein said outer shell is made out of a magnetic conductive material.

2. The EMI protective magnetic read head as claimed in claim 1, wherein said magnetic conductive material is a metal alloy containing at least 50% ferrite.

3. The EMI protective magnetic read head as claimed in claim 2, wherein said magnetic conductive material is ferrite.

4. The EMI protective magnetic read head as claimed in claim 2, wherein said magnetic conductive material is silicon steel.
